(19) United States
(12) Patent Application Publication
(10) Pub. No.: US 2004/0051635 A1
(43) Pub. Date: Mar. 18, 2004

(54) Vehicle brake indicating device

(76) Inventor: Lien-Fu Lu, Taipei (TW)

Correspondence Address: Lien-Fu Lu, 235 Chung-Ho Box 8-24, Taipei, TW

(21) Appl. No.: 10/244,847

(22) Filed: Sep. 17, 2002

(51) Int. Cl. B60Q 1/44

(52) U.S. Cl. 340/479

(57) ABSTRACT

A vehicle brake indicating device has a pendulum which has a plurality of long holes. The arrangement of long holes are based on a logic truth table. Two detecting elements are on the pendulum. When the pendulum swings, the upper and lower detecting element and detecting element are placed in long holes or round arc surface which are mapped to values in a truth table; so that a set of truth values in the truth table is derived. A control circuit has an electronic circuit controller. The outputs of the electronic circuit controller are connected to the lift turn light and right turn light, a deceleration light and a staged-illumination third braking light so as to present various illuminations. By the detecting elements to detect signals which are sent to the electronic circuit controller so as to present various aleRT1ng effect.

### FIELD OF THE INVENTION

The present invention relates to vehicle brake indicating devices, and paRT1cularly to a vehicle brake indicating device which provides various ways for indicating the car brake conditions.

### BACKGROUND OF THE INVENTION

In general, alarm device for aleRT1ng braking of a car is formed by a third brake light which is connected to the brake lights. However, the information is insufficient to the rear driver to know the condition of the former car easily. Therefore, it is possible that the rear driver takes an incorrect decision to cause an accident.

To improve this defect, in the prior art, a controller is used. The controller has a curved tube which is mounted obliquely. A movable touch element or a sensitive optical-electric element is installed within the curved tube for receiving brake signals from a car. Different control signals are outputted by switching of different optical-electric switch and an alarm device. The alarm device generates different alarm signals based on the control signals of the control circuit. The features of this prior art is that the alarm device has at least two display units which display messages by different colors so as to identify and display the brake condition of the car.

In above device, the controller has a touch element installed in the curved tube. The brake condition is detected by optical-electric switches at two sides. The beads of the touch element rolls forwards based on ineRT1a of the element. The brake condition is informed to a plurality of optical-electric switches so as to know the level of brake.

The alarm condition is identified by a controller. However, this kind of prior art has following defects:

1. In the touch element, roll beads roll in the curved tube. Since the beads have accelerations due to gravitation force, the moving lengths of the beads can not be controlled precisely to response the brake level of the car. Moreover, if the road is not flat, the beads rolls irregularly so that the preciseness is too low to response the brake condition.

2. For present different alarm conditions, the number of the optical-electric switches must be increased. This will increase the cost and the assembly work is complicated.

3. The alarm device only provides different flash effect to the third brake light, but the effect cannot be used to the original brake light. Thus, it can not match the rules used in America and Europe.

### SUMMARY OF THE INVENTION

Accordingly, the object of the present invention is to provide a vehicle brake indicating device having a pendulum which has a plurality 1 5 of long holes. The arrangement of long holes are based on a logic truth table. Two detecting elements are mounted on the pendulum. When the pendulum swings, the upper and lower detecting element and detecting element are placed in long holes or round arc surface which are mapped to values in a truth table; so that a set of truth values in the truth table is derived. A control circuit has an electronic circuit controller. A first output of the electronic circuit controller is connected to the lift turn light and right turn light. A second output end of the electronic circuit controller is connected to a deceleration light. Third outputs of the electronic circuit controller are connected to a staged-illumination third braking light which is formed by a plurality of transistors connected in parallel, and each two outputs of two adjacent transistors are serially connected with a resistor so as to present various illuminations. By the detecting elements to detect signals which are sent to the electronic circuit controller so as to present various aleRT1ng effect.

The various objects and advantages of the present invention will be more readily understood from the following detailed description when read in conjunction with the appended drawing.

### BRIEF DESCRIPTION OF THE DRAWINGS

FIG. 1 is an exploded perspective view of the pendulum of the present invention.

FIG. 2 is an assembled perspective view of the pendulum of the present invention.

FIG. 3 shows one embodiment of the electronic circuit controller according to the present invention.

FIG. 4 shows the logic truth table which is corresponding to the signal positions detected by the detecting elements.

### DETAILED DESCRIPTION OF THE PREFERRED EMBODIMENTS

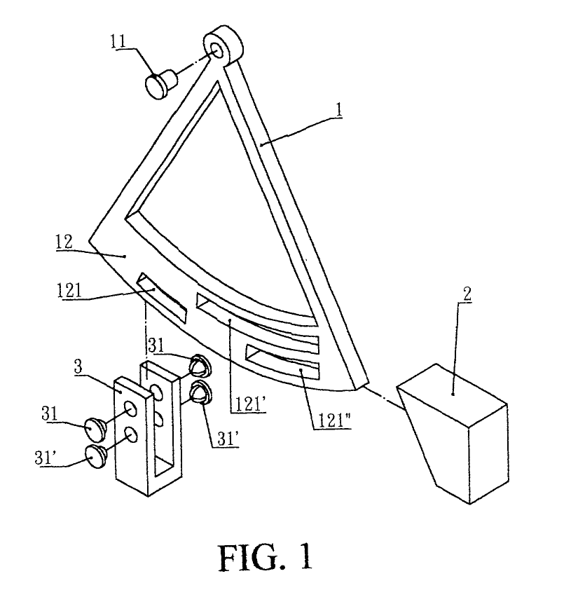

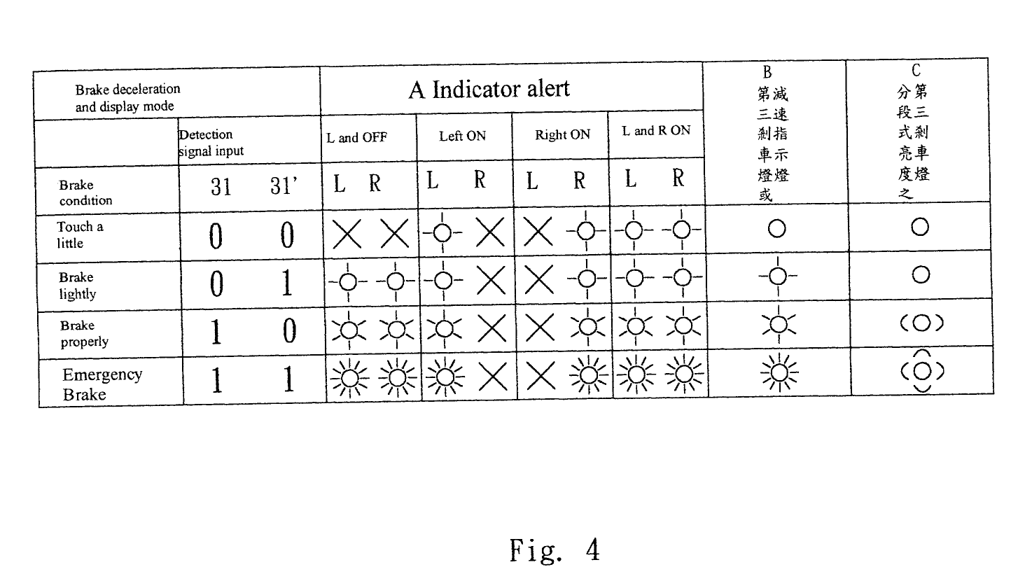

Referring to FIGS. 1 to 3, the present invention is illustrated. In the vehicle brake indicating device, a top end of a pendulum 1 is pivotally connected to a shaft stud 11 and a lower end of the pendulum 1 is aforementioned with a round arc surface 12. A plurality of a hollow long hole 121, a long hole 121′ and a long hole 121″ are formed on the round arc surface 12. The arrangement of long holes is based on a logic truth table (referring to FIG. 4). A rear end of the pendulum 1 is installed with a stopper 2 and two sides of the front end of the pendulum 1 are crossed by a detecting element retaining seat 3. The upper side and lower side of the retaining seat 3 are fixed with a respective detecting element 31 and detecting element 31′, respectively. Thereby, when the pendulum 1 swings, the upper and lower detecting element 31 and detecting element 31′ are placed in the upper and lower long hole 121 30 and long hole 121′. When the level of brake is changed, the detecting element 31 and detecting element 31′ in the upper and lower long hole 121 and long hole 121′ can detect signals. If the detecting elements are not in the upper and lower long holes, no signal is detected. Therefore, the logic truth value illustrated in FIG. 4 can be constructed. By the output signal from a control circuit, the variations of the left and right turn lights, or deceleration lights (i.e. third brake light), etc. can be presented as an alarm.

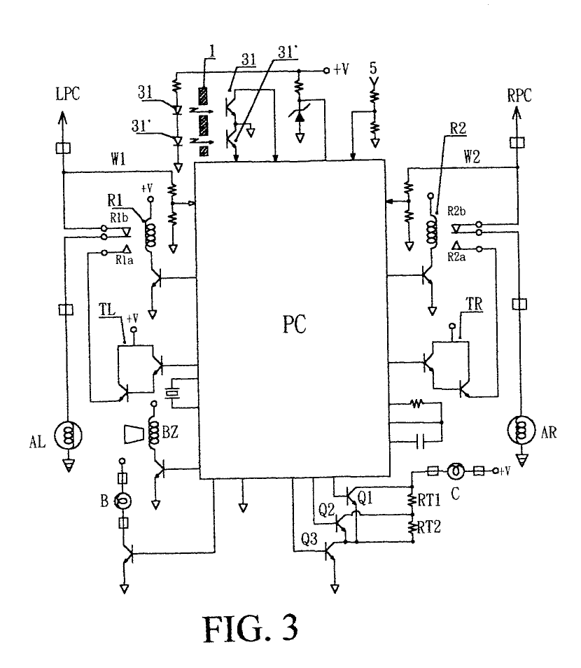

Referring to FIG. 3, the control circuit 4 is connected to a left relay R1 and a right relay R2 through an electronic loop controller. The left relay R1 and right relay R2 are coupled to a left normal close joint R1b, right normal close joint R2b, a left normal open joint R1a and, and a right normal open joint R2a. The left normal close joint Rlb is connected to the left turn light wire junction board LPC and the lift turn light AL in parallel, and the right normal close joint R2b is connected to the right turn light wire junction board RPC and the right turn light AR in parallel. The left normal open joint R1a is connected to a left amplifier TL and the right normal open joint R2a is connected to a right amplifier TR. Moreover, the output end of the electronic circuit controller PC is connected to a deceleration light B and a buzzer circuit BZ. Outputs of a plurality of transistors Q1, Q2 and Q3 are parallelly connected, where a resistor RT1 is connected between the output of the transistor Q1 and transistor Q2 and a resistor RT2 is connected between the transistor Q2 and transistor Q3. Then, the output of the transistor Q1 is connected to a staged-illumination third braking light C so as to provide various resistors. Thereby, the staged-illumination third braking light C has different illumination. The output signals of detecting element 31 and detecting element 31′ are sent to the electronic circuit controller PC, and then a predetermined control signal is outputted.

Thereby, the present invention has three brake alarm modes. One is by the lift turn light and right turn light, the second is by deceleration light B, the other is by the staged-illumination third braking light C. The combinations of these three modes are allowable.

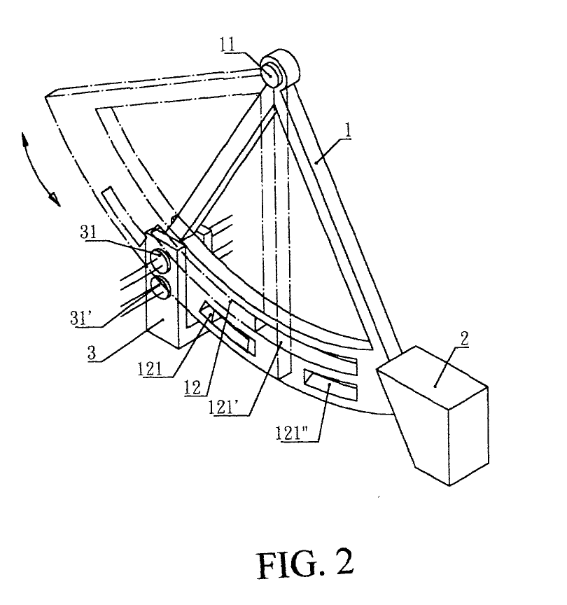

Referring to FIGS. 2, 3 and 4, when only a brake plate is slight touched without inducing any practical brake effect, the pendulum 1 can not swing forwards, namely, the detecting element 31 and detecting element 31′ are on the round arc surface 12. That is, no detecting signal is inputted into the electronic circuit controller PC. In the truth table, (0, 0) are presented. Since the left relay R1 ad the right relay R2 are connected to the left turn light wire junction board LPC and right turn light wire junction board RPC through the left normal close joint Rlb and right normal close joint R2b, the lift turn light AL and right turn light AR are retained in actuation condition.

Since the input of the brake signal 5 is inputted to the electronic circuit controller PC. The deceleration light B light ups continuously. If the staged-illumination third braking light C is used, only the transistor Q3 conducts, that is the resistor RT1 and resistor RT2 are serially connected to the staged-illumination third braking light C to present a lower illumination.

When the brake device is slightly actuated, the pendulum 1 swings forwards due to ineRT1a. Thereby, the lower detecting element 31′ is positioned in the lower long hole 121′ in the round arc surface 12. And, the upper detecting element 31 is positioned on the round arc surface 12. Namely, only the detecting element 31′ detects signals. In truth table, it is presented by 0 and 1. The signal is inputted to the electronic circuit controller PC. Then signals are outputted to actuate left relay R1 and right relay R2 so that the left normal open joint R1a and right normal open joint R2a are actuated. Then, the lift turn light AL and right turn light AR are connected to the left amplifier TL and right amplifier TR to be connected to the electronic circuit controller PC so that the lift turn light AL and right turn light AR are in low flash condition. If a staged-illumination third braking light C is used, then the transistor Q3 is conducted, the resistor RT1 and resistor RT2 are serially connected to the staged-illumination third braking light C so as to provide a low illumination condition. If the lift turn light AL and right turn light AR are used at the same time as in braking, the left turn light wire junction board LPC and right turn light wire junction board RPC will output signals, then the left detecting circuit W1 or the right detecting circuit W2 will detect the signals and sent the detected signals to the electronic circuit controller PC for interrupting the outputs of the left amplifier and the right amplifier so that the lift turn light AL and right turn light AR is interrupted. When braking operation is stopped, no braking signal is inputted to the electronic circuit controller PC. The system returns to the original condition.

As above described, when the brake is actuated with a normal level, the pendulum 1 will swing forwards, the detecting element 31 enters into the upper long hole 121 and the detecting element 31′ enters into a close area of the round arc surface 12. The logic value is not equal to 1 and 0. Thereby, the detected signals are inputted to the electronic circuit controller PC and at the same time, preset signals are outputted to the left relay R1 and right relay R2. Thereby, the left normal open joint R1a and right normal open joint R2a actuates, the lift turn light AL and right turn light AR are thereof to the left amplifier TL and right amplifier TR to be connected to the electronic circuit controller PC so that the lift turn light AL and right turn light AR to flash in a middle level. The deceleration light B also flashes in a middle level. If the staged-illumination third braking light C is used, then the transistor Q1 and transistor Q2 are conducted. The resistor RT1 is connected to the staged-illumination third braking light C so that the resistor is smaller so as to provide a middle level illumination. If in braking, the lift turn light AL and right turn light AR are used at the same time, the left turn light wire junction board LPC or right turn light wire junction board RPC will output signals. The left detecting circuit W1 or the right detecting circuit W2 will detect signals which are sent to the electronic circuit controller PC for interrupting the left amplifier TL or the right amplifier TR so that the lift turn light AL or right turn light AR is interrupted. Thereby, the operation of the original turn light is sustained.

In emergent braking, the pendulum 1 swings forwards, the upper detecting element 31 and lower detecting element 31′ enter into the long hole 121 and long hole 121′, respectively so that the values in truth table are (1, 1). The detected signals are inputted to the electronic circuit controller PC. Meanwhile, preset signals are outputted to the left relay R1 and right relay R2. The left normal open joint R1a and right normal open joint R2a actuates, the lift turn light AL and right turn light AR flash in a high level. Further, the deceleration light B also flashes in high level. If the staged-illumination third braking light C is used, the transistors Q1, Q2 and Q3 are conducted so that the resistor is equal to zero. The signal is directly inputted to the staged-illumination third braking light C so as to present a high illumination.

If in braking, the lift turn light AL and right turn light AR are used as the same time, the left turn light wire junction board LPC and right turn light wire junction board RPC will output signals. The left detecting circuit W1 and right detecting circuit W2 will detect signals and then sends the signals to the electronic circuit controller PC so as to interrupt the output of the left amplifier TL and the right amplifier TR so that the lift turn light AL and the right turn light AR is interrupted so as to provide the original turn light function. Thereby, a flash effect is preferred.

Therefore, only by the detecting elements to enter into the long holes by the swinging of the pendulum 1, different logic values in the truth table can be derived. Through the alarming conditions set in the electronic circuit controller PC, various selections can be presented.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A vehicle brake indicating device comprising:
a pendulum, a top end of the pendulum being pivotally connected to a shaft stud and a lower end of the pendulum being a round arc surface; a plurality of hollow long holes being formed in the round arc surface;
the arrangement of long holes being based on a logic truth table; a rear end of the pendulum being installed with a stopper;
two detecting elements installed on a detecting element retaining seat crossing two sides of a front end of the pendulum; the upper side and lower side of the retaining seat being fixed with an upper detecting element and a lower detecting element, respectively; wherein, when the pendulum swings, the upper and lower detecting elements being placed in the long holes or round arc surface; the positioning of the upper and lower detecting elements being mapped to one of a plurality of pair of truth values in a truth table; so that a pair of truth values in the truth table is derived;
a control circuit connected to a left relay and a right relay through an electronic loop controller; the left relay and right relay being coupled to a left normal close joint, a right normal close joint, a left normal open joint, and a right normal open joint; a left normal close joint being connected to a left turn light wire junction board and a lift turn light in parallel, and the right normal close joint being connected to a right turn light wire junction board and a right turn light in parallel; a left normal open joint being connected to a left amplifier and the right normal open joint being connected to a right amplifier; moreover, an output end of the electronic circuit controller being connected to a deceleration light;
and outputs of the electronic circuit controller being connected to an staged-illumination third braking light which is formed by a plurality of transistors which are connected in parallel, and each two outputs of two adjacent transistors being serially connected with a resistor so as to present various illuminations;
wherein by the detecting elements to detect signals which are sent to the electronic circuit controller so as to present various alerting effect.

2. The vehicle brake indicating device as claim in claim 1, wherein the electronic circuit controller is connected to one of turn lights, braking lights, deceleration lights, and the combination thereof so as to inform the condition of these device to the user.

3. The vehicle brake indicating device as claim in claim 1, wherein a buzzer circuit is connected to the electronic circuit controller to alert an emergent condition.

4. The vehicle brake indicating device formed by detecting elements and a control circuit; wherein when a driver brakes a vehicle, the braking level is detected by the detecting elements as braking signals and then braking signals are sent to the control circuit, then the control circuit causes a lift turn light and a right turn light to light up with different levels according to a braking level; and left turning or right turning of the car is controlled by the controlled circuit so as to interrupt one turn light; and the effect due to baking a car is retained in the turn light not to be interrupted.
